(19) United States
(12) Patent Application Publication
(10) Pub. No.: US 2019/0111449 A1
(43) Pub. Date: Apr. 18, 2019

(54) PUMP BOTTLE STRAW ATTACHMENT

(71) Applicant: Abel Mengisteab, Alexandria, VA (US)

(72) Inventor: Abel Mengisteab, Alexandria, VA (US)

(21) Appl. No.: 16/155,912

(22) Filed: Oct. 10, 2018

Related U.S. Application Data
(60) Provisional application No. 62/571,966, filed on Oct. 13, 2017.

(51) Int. Cl. B05B 15/30; B05B 11/00

(52) U.S. Cl. CPC B05B 15/30; B05B 11/3001; B05B 11/0059

(57) ABSTRACT

A pump bottle straw attachment device configured to aid in the removal of a material from a bottle or container having a pump dispensing mechanism utilizing a straw. The device configured for removable receipt on the straw and having an adjustable length. The device having an end with a plurality of flexible extension members with free ends configured to reach several areas of the container the device is placed within.

### CROSS REFERENCE TO RELATED APPLICATIONS

This application claims priority to U.S. Provisional Patent Application No. 62/571,966 filed 13 Oct. 2017 to the above named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The invention relates generally to a straw attachment for a pump assembly within a bottle configured to reach multiple areas along the bottom portion of the bottle the device is placed within.

### BACKGROUND

Often when using a container shaped and configured for holding a fluid or fluid-like material, such as a soap, a user will dispense the material though a pump mechanism placed within the container, such as a bottle. A standard pump assembly typically comprises a pump mechanism in communication with a stem portion, or straw that is placed into the material and typically aligned with a center portion of the container. Due to the alignment of the stem portion, often the user is not able to completely empty the contents of the container.

Current solutions to this problem generally require the user to remove the pump mechanism from the container and use physical manipulation, such as tipping, squeezing, taping, and other similar emptying means. Therefore, there is a need within the market for a device to aid a user in emptying the contents of a container having a stem portion coupled to a pump mechanism. Preferably this solution is configured for universal use, adjustable, and durable for multiple uses.

### SUMMARY OF THE INVENTION

A straw attachment of a pump bottle assembly generally configured to enable a user to empty the contents of a bottle without additional intervention by a user. The device of the present disclosure is configured for removable attachment to the stem portion or straw portion of a pump mechanism for generally reaching multiple areas of the container the device is placed within. The device is configured with an adjustable assembly to allow for placement and use in containers of multiple shapes and sizes.

The device is generally a universal attachment for the straw portion that is comprised of a flexible material and configured to provide a suction member at several positions along a bottom portion of the container.

In the preferred embodiment of the present disclosure, the device is comprised of at least one extension member comprised of a flexible material connected to a central hub. The extensions including a tip and a free end opposed the central hub. The tip generally having a tapered or beveled shape to encourage positioning and placement along the bottom of the container. Accordingly, the device extension(s) reach to several positions at the container bottom, including the corners to allow for the removal of the complete contents of the bottle through the pump mechanism.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 shows the top of device, according to the present disclosure;

FIG. 2 shows the right side of device, according to the present disclosure;

FIG. 3 shows a perspective view of device, according to the present disclosure;

FIG. 4 shows the left side of device, according to the present disclosure;

FIG. 5 shows the front of device, according to the present disclosure;

FIG. 6 shows the plurality of extension portions of the device in a flexed position, according to the present disclosure;

FIG. 7 shows the bottom of device, according to the present disclosure; and

FIG. 8 shows the back of device, according to the present disclosure.

### DETAILED DESCRIPTION OF THE INVENTION

The following detailed description includes references to the accompanying drawing, which forms a part of the detailed description. The drawing shows, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

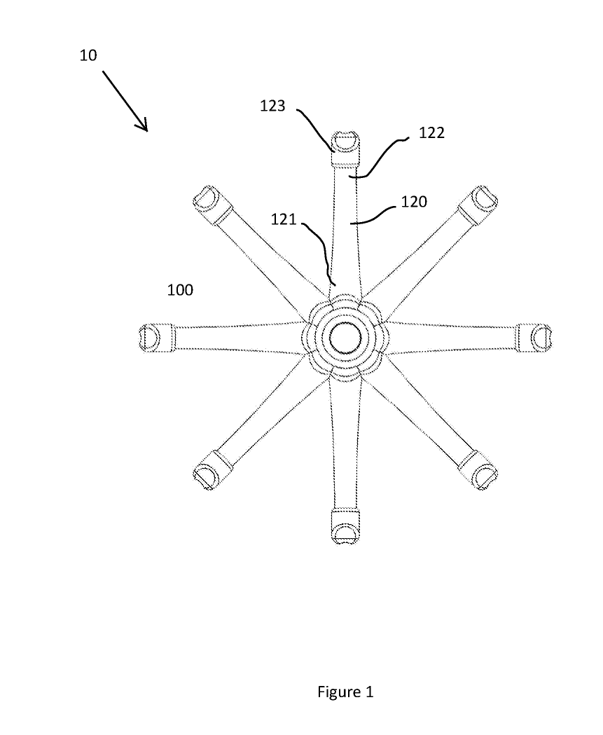

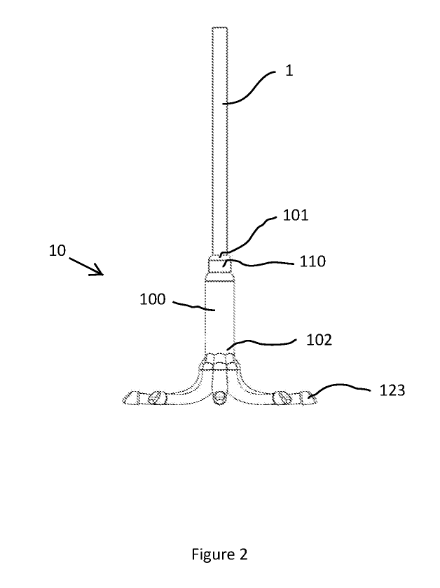

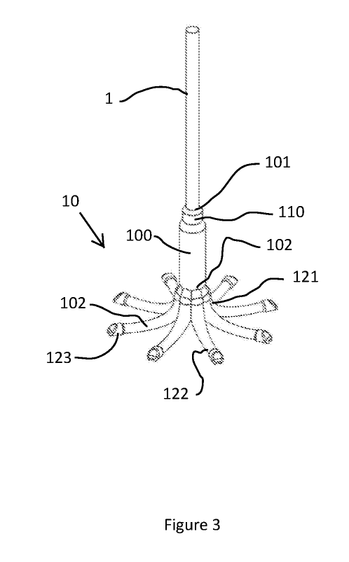

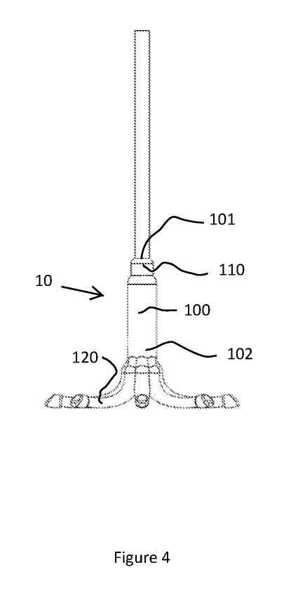

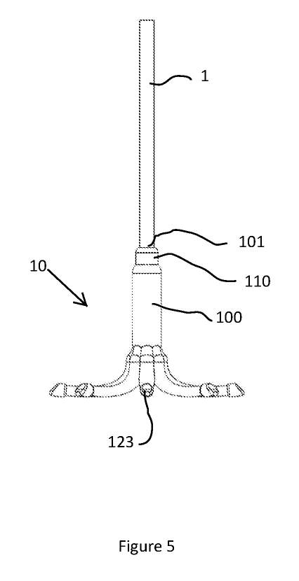

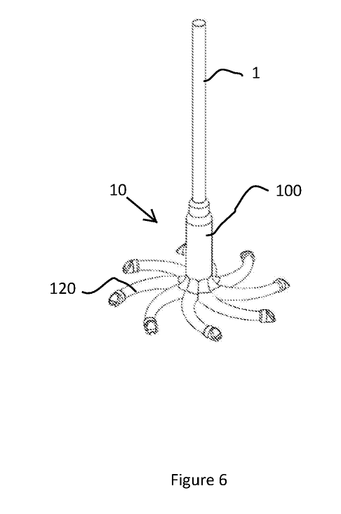

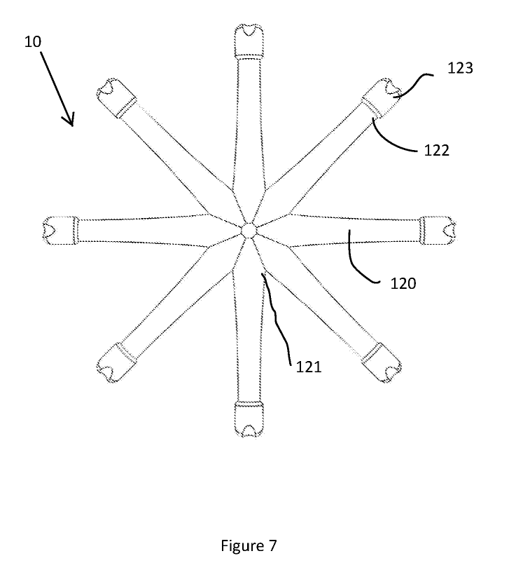

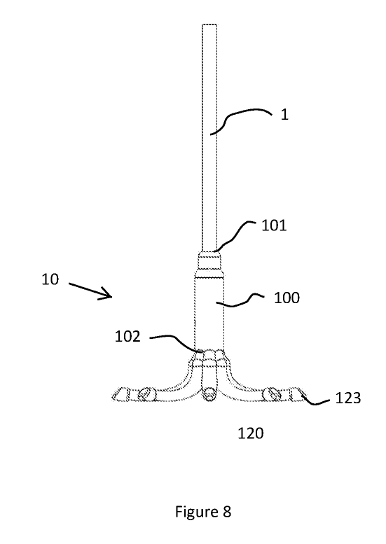

Referring to the figures, FIGS. 1-8 of a pump bottle straw attachment of the present disclosure generally referred to as device 10. The device 10 is most generally configured for universal coupling to a straw 1 or a stem portion 1 of a standard pump mechanism placed within a container for generally removing and dispensing the contents of the container. Accordingly, the device 10 during use is placed on a bottom portion of the dispensing or feed straw 1 of a container having a fluid or fluid-like material and positioned at the bottom of the container the device 10 is placed within for generally expanding the reach of the straw 1 to several additional areas and positions within the container.

The device 10 is comprised of body portion 100 having a first end 101 configured for coupling to the straw 1 and opposed a second end 102. The first end 101 having a length that is adjustable through a sleeve member 110 that is received within the body portion 100. The sleeve member 110 generally nestedly received within the body portion 100, wherein it may be slid out or in to the body portion 100 to increase or decrease the length of the device 10 defined as the distance between the first end 101 and second end 102. The sleeve member 110 including a locking mechanism, wherein the length can be adjusted and placed in a fixed position.

The first end 101 having a diameter sized for the receipt of the straw 1 and comprised of a resilient and flexible material, wherein the device 10 can be secured to the straw 1 by inserting the straw 1 into the first end 101 of the body portion 100.

The second end 102 functioning as a hub configured for the receipt of at least one extension member 120. The extension member 120 flexible and extending perpendicular outward from the second 102 at a fixed end 121 opposed a free end 122. The extension member 120 flexibility allowing for movement of the extension member 120 to enable for the placement of the device 10 into and out of the container the device 10 is placed within and enabling the free end 122 to reach various portions of the container the device 10 is placed within. Accordingly, the extension member 120 flexibility allows for movement in several directions wherein the extension member 120 may move in several positions, including but not limited to, bending, rotating, spinning, flexing, and twisting. The free end 122 including a rigid end portion 123 having an aperture and beveled in shape to prevent the collapsing of the extension when suction is applied.

In the preferred embodiment of the present disclosure, the device 10 includes (8) eight extension members 120 that generally conform to any container the device 10 is placed within, allowing for the suction of the contents of the bottle from multiple areas during use.

In use of the device 10, the first end 101 is coupled to the straw portion 1, wherein the device 10 extension member 120 is generally movable to a position parallel to the straw 1 during insertion into the container. After insertion into the container, the flexible properties of the extension member 120 generally move the unobstructed member 120 to a position perpendicular to the straw 1, wherein the free end 122 is generally migrated to a position more near the container interior edges.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A device configured for removable attachment to a straw portion of a pump assembly of a container of a material, the device comprising:
a body portion, the body portion coupled to the straw portion, the body portion having:
at least one extension member, the extension member comprised of a flexible material and extending perpendicular to a length of the straw.

2. The device as in claim 1, wherein the device includes at least three extension members.

3. The device as in claim 1, wherein the device includes eight extension members.

4. The device as in claim 1, wherein the body portion has a length extending between the straw and extension members, the length being adjustable.

5. The device as in claim 1, wherein the at least one extension member has a free end, the free end comprised of a rigid material and having a bevel shape.

6. A device configured for removable attachment to a straw portion of a pump assembly of a container of a material, the device comprising:
a body portion, the body portion having:
a first end, the first end configured for receipt on an end of the straw portion; and
a second end opposed the first end, a distance between the second end and the first end extending a length, the second end having at least one extension member, the extension member comprised of a flexible material and extending perpendicular to a length of the straw.

7. The device as in claim 6, wherein the device includes at least three extension members.

8. The device as in claim 6, wherein the device includes eight extension members.

9. The device as in claim 6, wherein the body portion length is adjustable.

10. The device as in claim 6, wherein the extension member has a free end, the free end comprised of a rigid material and having a bevel shape.

11. A device configured for removable attachment to a pump assembly of a container of a material dispensed through a straw, the device comprising:
a body portion, the body portion having:
a first end, the first end configured for removable receipt on an end of the straw, the first end including a sleeve member; and
a second end opposed the first end, the second end coupled to the sleeve member, wherein the a distance between the second end and the first end extends a length along the sleeve, the second end having at least one extension member, the extension member comprised of a flexible material and having an attached end coupled to the second end and a free end extending perpendicular to a length of the straw.

12. The device as in claim 11, wherein the device includes at least three extension members.

13. The device as in claim 11, wherein the device includes eight extension members.

14. The device as in claim 11, wherein the body portion length is adjustable by moving the second end along the sleeve member.

15. The device as in claim 11, wherein the free end is comprised of a rigid material and having a bevel shape.
